(19) United States
(12) Patent Application Publication
(10) Pub. No.: US 2026/0145483 A1
(43) Pub. Date: May 28, 2026

(54) VEHICLE THERMAL MANAGEMENT SYSTEMS WITH CONTROL LOGIC FOR REFRIGERANT HEAT RECOVERY FOR OPTIMIZED CABIN WARMING

(71) Applicant: GM GLOBAL TECHNOLOGY OPERATIONS LLC, Detroit, MI (US)

(72) Inventors: Viraj Vartak, Ferndale, MI (US); Satish P. Ketkar, Troy, MI (US); Kenny L. Inthiraj, Ypsilanti, MI (US)

(73) Assignee: GM GLOBAL TECHNOLOGY OPERATIONS LLC, Detroit, MI (US)

(21) Appl. No.: 18/958,467

(22) Filed: Nov. 25, 2024

(51) Int. Cl. B60H 1/00; B60H 1/32

(52) U.S. Cl. CPC B60H 1/00885; B60H 1/3227; B60H 1/32284; B60H 1/3229; B60H 2001/00307

(57) ABSTRACT

Presented are thermal management systems that recover thermal energy from working fluids to optimize vehicle compartment heating, methods for making/using such systems, and vehicles equipped with such systems. A vehicle thermal management system includes a coolant reservoir that attaches to a vehicle's body and stows coolant fluid. Also attached to the vehicle body is a coolant circuit that is fluidly coupled to the coolant reservoir to circulate the coolant fluid. A cabin heating condenser (CHC) is fluidly coupled to a high-pressure section of the coolant circuit, and an evaporator is fluidly coupled to a low-pressure section of the coolant circuit. The evaporator and CHC may be packaged inside a module housing with an air passage that receives ambient air from outside the vehicle, passes the received air across the evaporator to warm the ambient air, and transmits the warmed air into the CHC to thereby heat the vehicle's passenger cabin.

### INTRODUCTION

The present disclosure relates generally to thermal management systems. More specifically, aspects of this disclosure relate to active thermal management systems that enable heat recovery for improved warming of passenger cabins of motor vehicles.

Current production motor vehicles, such as the modern-day automobile, are originally equipped with an onboard thermal management system that helps to regulate the passenger cabin temperature and the operating temperatures of the vehicle's various heat-generating components. Active thermal management (ATM) systems for automotive applications, for example, normally employ a dedicated electronic control module (ECM) to regulate operation of cooling circuits that distribute coolant through heat-producing powertrain components and the vehicle's heating, ventilation, and air conditioning (HVAC) module. For many hybrid and electric vehicles, the in-vehicle active thermal management system may use multiple independent thermal subsystems for cooling discrete segments of the powertrain. Some hybrid electric vehicle (HEV) and full-electric vehicle (FEV) ATM architectures implement a dedicated coolant loop for the vehicle powertrain components, a separate coolant loop for the battery pack and power electronics (PE) packages, and yet another distinct coolant loop for regulating passenger cabin temperatures. During operation of a vehicle ATM system, the heat sinks through which thermal energy is extracted from the coolant fluid may expel heat from the vehicle into the surrounding ambient environment.

### SUMMARY

Presented below are vehicle ATM systems with control logic for recovering thermal energy from working fluids for optimized vehicle compartment warming, methods for making and methods for operating such systems, and motor vehicles equipped with such systems. By way of non-limiting example, a receiver-dryer (RD) or accumulator (ACC) based vehicle ATM HVAC system recovers refrigerant heat that is expelled from a low-pressure evaporator branch of a refrigerant circuit to warm incoming ambient air. The warmed ambient air is fed across the evaporator and into a cabin heating condenser (CHC) on a high-pressure condenser branch of the refrigerant circuit to thereby provide warmer air to the vehicle's passenger cabin. Many conventional refrigerant circuits disable the low-pressure evaporator branch during cabin heating and heat pump operations. Disclosed vehicle ATM systems, in contrast, open dedicated evaporator-side expansion valves that feed refrigerant into an evaporator and a chiller during cabin heating. To enable refrigerant heat recovery, however, the evaporator is operated as a condenser—rather than an evaporator—with an operating temperature that is higher than ambient air temperature. Running the evaporator in a condensing mode functions to both increase an air temperature of incoming ambient air for faster initial cabin warmup and to increase refrigerant mass flow through the circuit by opening parallel paths through the evaporator and chiller.

Aspects of this disclosure are directed to active thermal management systems with control logic for provisioning recovery of thermal energy from working fluids for optimized heating of passenger compartments. In an example, a vehicle thermal management system includes a coolant reservoir (e.g., low-side and high-side charge ports coupled to a refrigerant container) that attaches to a vehicle's body and stows therein coolant fluid (e.g., refrigerant). Also attached to the vehicle body is a coolant circuit (e.g., interconnected hoses, connectors, passages, etc.) that fluidly couples to the coolant reservoir and circulates the coolant fluid. A cabin heating condenser (CHC) (e.g., air-cooled or liquid-cooled serpentine condenser) is fluidly coupled to a high-pressure (HP) section of the coolant circuit and selectively condenses the coolant fluid. An evaporator (e.g., orifice-tube or expansion-valve evaporator) is fluidly coupled to a low-pressure (LP) section of the coolant circuit and selectively evaporates the coolant fluid. An air passage (e.g., HVAC module vents and ducts) receives ambient air, passes the ambient air across the evaporator to thereby warm the received air, and transmits the warmed air into the CHC to thereby heat the vehicle passenger cabin

Additional aspects of this disclosure are directed to motor vehicles equipped with active thermal management systems that provision thermal energy recovery from working fluids for optimized heating of passenger compartments. As used herein, the terms “vehicle” and “motor vehicle” may be used interchangeably and synonymously to include any relevant vehicle platform, such as passenger vehicles, commercial vehicles, industrial vehicles, tracked vehicles, off-road and all-terrain vehicles (ATV), motorcycles, farm equipment, watercraft, aircraft, spacecraft, etc. In an example, a motor vehicle includes a vehicle body with a passenger cabin, multiple road wheels rotatably mounted to the vehicle body (e.g., via wheel corner modules coupled to a unibody or body-on-frame chassis), and other standard original equipment. For electric-drive vehicle applications, one or more electric traction motors operate alone (e.g., for FEV powertrains) or in conjunction with an internal combustion engine assembly (e.g., for HEV powertrains) to selectively drive one or more of the road wheels to thereby propel the vehicle.

Continuing with the discussion of the foregoing example, the motor vehicle also includes an active thermal management (ATM) system that is attached to the vehicle body and operable to regulate a cabin temperature of the passenger cabin. The vehicle's ATM system includes a coolant reservoir that stows coolant fluid, and a coolant circuit that fluidly couples to the coolant reservoir to circulate the coolant fluid in order to cool and heat the passenger cabin. A cabin heating condenser is fluidly coupled to a high-pressure section of the coolant circuit, and an evaporator is fluidly coupled to a low-pressure section of the coolant circuit. The evaporator and condenser may be packaged inside a module housing with an air passage that receives ambient air, e.g., from outside the vehicle or recirculated from the passenger cabin, passes the received air across the evaporator to warm the air, and transmits the warmed ambient air into the CHC to help heat the passenger cabin. Fluidly coupled to the HP section of the coolant circuit, upstream from the CHC, is a first fluid valve that selectively fluidly connects the evaporator to the CHC. Fluidly coupled to the LP section of the coolant circuit, upstream from the evaporator, is a second fluid valve that selectively fluidly connects the CHC to the evaporator. An ATM system controller is programmed to respond to a request to heat the passenger cabin by concurrently opening both of the fluid valves to pass the coolant fluid through the first fluid valve, the CHC, the second fluid valve, and the evaporator.

Aspects of this disclosure are also directed to system control logic, workflow control protocols, and computer-readable media (CRM) for making or for using any of the herein-described vehicle thermal management systems. In an example, a method is presented for assembling a thermal management system of a motor vehicle, which includes a vehicle body with a vehicle passenger cabin. This representative method includes, in any order and in any combination with any of the above and below disclosed options and features: attaching a coolant reservoir to the vehicle body, the coolant reservoir being configured to stow coolant fluid; attaching a coolant circuit to the vehicle body, the coolant circuit having a high-pressure circuit section and a low-pressure circuit section; fluidly coupling the coolant circuit to the coolant reservoir, the coolant circuit being configured to circulate the coolant fluid; fluidly coupling a cabin heating condenser to the HP circuit section; fluidly coupling an evaporator to the LP circuit section; and fluidly connecting an air passage to the evaporator and the CHC, the air passage being configured to receive ambient air from outside the motor vehicle, pass the ambient across the evaporator to thereby generate warmed ambient air, and transmit the warmed ambient air into the CHC to thereby heat the vehicle passenger cabin.

For any of the disclosed systems, vehicles, and methods, a first fluid valve may be fluidly coupled to the HP circuit section upstream from the CHC and a second fluid valve may be fluidly coupled to the LP circuit section upstream from the evaporator. In this instance, the first fluid valve may selectively fluidly connect an evaporator outlet of the evaporator to a CHC inlet of the CHC, and the second fluid valve may selectively fluidly connect a CHC outlet of the CHC to an evaporator inlet of the evaporator. A resident or remote controller, central processor, control module, programmable logic device, or network of controllers/processors/modules/devices/etc. (collectively “system controller”) may be programmed to concurrently open both the first and second fluid valves to thereby pass coolant fluid through the first fluid valve, the CHC, the second fluid valve, and the evaporator during heating of the vehicle passenger cabin. For some system architectures, the first fluid valve is an electronic refrigerant flow valve (RFV) that is interposed between the evaporator and the CHC, and the second fluid valve is an electronic expansion valve (EXV) that is interposed between the evaporator and the CHC.

For any of the disclosed systems, vehicles, and methods, a fluid chiller may be fluidly coupled to a first branch circuit of the LP circuit section and operable to extract thermal energy from the coolant fluid to thereby chill the coolant. In this instance, the evaporator may be fluidly coupled to a second LP branch circuit that is fluidly connected in parallel to the first LP branch circuit. A third fluid valve (e.g., a chiller EXV) may be fluidly coupled to the LP circuit section upstream from the fluid chiller and operable to selectively fluidly connect the CHC outlet to the chiller inlet. In this instance, the system controller may respond to a request to heat the passenger cabin by concurrently opening the first, second and third fluid valves such that coolant fluid passes through the first fluid valve, the CHC, the second and third fluid valves, and the evaporator and fluid chiller.

For any of the disclosed systems, vehicles, and methods, an electric compressor may be fluidly coupled to the coolant circuit, interposed between the evaporator and CHC, and operable to increase a temperature and a pressure of the coolant fluid. In this instance, a fourth fluid valve (e.g., passive one-way check valve (CV)) may be fluidly coupled to the LP circuit section, upstream from the electric compressor, and operable to selectively fluidly connect the evaporator to the compressor. The first fluid valve may be fluidly interposed between and actuable to selectively fluidly connect the electric compressor to the CHC. As a further option, an external condenser (ECond) may be fluidly coupled to a first branch circuit of the HP circuit section and operable to expel thermal energy from the coolant fluid into the ambient environment. In this instance, the CHC may be fluidly coupled to a second HP branch circuit that is fluidly connected in parallel to the first HP branch circuit. A fifth fluid valve (e.g., (an outside heat exchanger (OHX) RFV) may be fluidly coupled to the HP circuit section, upstream from the external condenser, and actuable to selectively fluidly connect the external condenser to the evaporator. In this instance, the system controller may automatically close the fifth fluid valve concurrent with the opening of the first and second fluid valves such that coolant fluid does not pass through the external condenser during the heating of the vehicle passenger cabin.

For any of the disclosed systems, vehicles, and methods, an RD-based refrigerant system may fluidly couple a receiver dryer to the coolant circuit, e.g., interposed between the evaporator and the CHC. In this instance, the receiver dryer may contain a filter and a desiccant material to remove moisture, debris and contaminants from the coolant fluid. A sixth fluid valve (e.g., passive one-way CV) may be fluidly interposed between and operable to selectively fluidly connect the CHC to the receiver dryer. The second fluid valve may be fluidly interposed between and actuable to selectively fluidly connect the receiver dryer to the evaporator. For an ACC-based system, the LP circuit section may be generally fluidly isolated from the HP circuit section; an internal heat exchanger (IHX) may be interposed between and passively thermally couple the LP circuit section and the HP circuit section. In this instance, an accumulator may be fluidly coupled to the LP circuit section, interposed between the evaporator and the IHX. The accumulator may selectively fluidly connect the LP circuit section to the HP circuit section and may store therein a portion of the coolant fluid to thereby reduce a fluid pressure in the LP circuit section and/or HP circuit section of the coolant circuit.

The above summary does not represent every embodiment or every aspect of the present disclosure. Rather, the foregoing summary merely provides a synopsis of some of the novel concepts and features set forth herein. The above features and advantages, and other features and attendant advantages of this disclosure, will be readily apparent from the following Detailed Description of illustrated examples and representative modes for carrying out the disclosure when taken in connection with the accompanying drawings and appended claims. Moreover, this disclosure expressly includes any and all combinations and subcombinations of the elements and features presented above and below.

### BRIEF DESCRIPTION OF THE DRAWINGS

FIG. 1 is a partially schematic, side-view illustration of a representative motor vehicle equipped with an active thermal management (ATM) system for optimized heating of internal vehicle compartments in accordance with aspects of the present disclosure.

FIG. 2 is a schematic illustration of a representative receiver-dryer (RD) based vehicle ATM system that provisions refrigerant heat recovery for optimized passenger cabin warming in accordance with aspects of the present disclosure.

FIG. 3 is a schematic illustration of a representative accumulator (ACC) based vehicle ATM system that provisions refrigerant heat recovery for optimized passenger cabin warming in accordance with aspects of the present disclosure.

The present disclosure is amenable to various modifications and alternative forms, and some representative embodiments of the disclosure are shown by way of example in the drawings and will be described in detail herein. It should be understood, however, that the novel aspects of this disclosure are not limited to the particular forms illustrated in the above-enumerated drawings. Rather, this disclosure covers all modifications, equivalents, combinations, permutations, groupings, and alternatives falling within the scope of this disclosure as encompassed, for example, by the appended claims.

### DETAILED DESCRIPTION

This disclosure is susceptible of embodiment in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Introduction, Summary, Brief Description of the Drawings, and Detailed Description sections, but not explicitly set forth in the claims, should not be incorporated into the claims, singly or collectively, by implication, inference or otherwise. Moreover, recitation of “first”, “second”, “third”, etc., in the specification or claims is not per se used to establish a serial or numerical limitation; unless specifically stated otherwise, these designations may be used for ease of reference to similar features in the specification and drawings and to demarcate between similar elements in the claims.

For purposes of this disclosure, unless specifically disclaimed: the singular includes the plural and vice versa (e.g., indefinite articles “a” and “an” should generally be construed as meaning “one or more”); the words “and” and “or” shall be both conjunctive and disjunctive; the words “any” and “all” shall both mean “any and all”; and the words “including,” “containing,” “comprising,” “having,” and the like, shall each mean “including without limitation.” Moreover, words of approximation, such as “about,” “almost,” “substantially,” “generally,” “approximately,” and the like, may each be used herein to denote “at, near, or nearly at,” or “within 0-5% of,” or “within acceptable manufacturing tolerances,” or any logical combination thereof, for example. Lastly, directional adjectives and adverbs, such as fore, aft, inboard, outboard, starboard, port, vertical, horizontal, upward, downward, front, back, left, right, etc., may be with respect to a motor vehicle, such as a forward driving direction of a motor vehicle when the vehicle is operatively oriented on a horizontal driving surface.

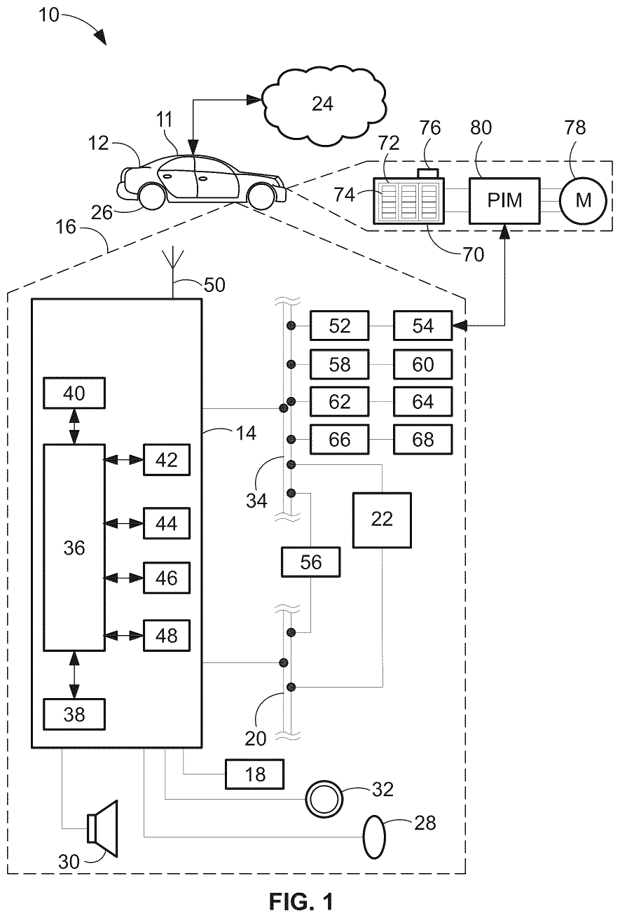

Referring now to the drawings, wherein like reference numbers refer to like features throughout the several views, there is shown in FIG. 1 a representative motor vehicle, which is designated generally at 10 and portrayed herein for purposes of discussion as a sedan-style, electric-drive automobile. The illustrated automobile 10—also referred to herein as “motor vehicle” or “vehicle” for short—is merely an exemplary application with which aspects of this disclosure may be practiced. In the same vein, incorporation of the present concepts into the two illustrated ATM systems for heating a vehicle passenger cabin should be appreciated as non-limiting implementations of disclosed features. As such, it will be understood that aspects and features of this disclosure may be implemented by other thermal management system architectures, may be utilized for heating other vehicle compartments, and may be incorporated into any logically relevant type of vehicle. Moreover, only select components of the motor vehicle and thermal management systems are shown and described in detail herein. Nevertheless, the vehicles and systems discussed below may include numerous additional and alternative features, and other available peripheral hardware, for carrying out the various methods and functions of this disclosure.

The representative vehicle 10 of FIG. 1 is originally equipped with a vehicle telecommunications and information (“telematics”) unit 14 that wirelessly communicates, e.g., via cellular network, satellite service, wireless-enabled modem, etc., with a remotely located or “off-board” cloud computing host service 24 (e.g., ONSTAR®). Some of the other vehicle hardware components 16 shown in FIG. 1 include, as non-limiting examples, a video display device 18, a microphone 28, audio speaker(s) 30, and assorted user input controls 32 (e.g., buttons, knobs, switches, touchscreens, etc.). These components 16 function, in part, as a human/machine interface (HMI) that enables a user to communicate with the telematics unit 14 and other components both resident to and remote from the vehicle 10. Microphone 28, for instance, provides occupants with a means to input verbal commands; the vehicle 10 employs embedded audio filtering, editing, and analysis modules for processing the commands. Conversely, the speaker 30 provides audible output to vehicle occupants and may be either a stand-alone speaker or may be part of an audio system 22. The audio system 22 is connected to a network connection interface 34 and an audio bus 20 to receive analog information, rendering it as sound, via one or more speaker components.

Communicatively coupled to the telematics unit 14 is a network connection interface 34, suitable examples of which include fiberoptic Ethernet switches, parallel/serial communications buses, local area network (LAN) interfaces, controller area network (CAN) interfaces, and the like. The network connection interface 34 enables the vehicle hardware 16 to send and receive signals with one another and with various systems both onboard and off-board the vehicle body 12. This allows the vehicle 10 to perform assorted vehicle functions, such as modulating powertrain output, activating friction and regenerative brake systems, controlling vehicle steering, and other automated functions. For instance, telematics unit 14 may exchange signals with a Powertrain Control Module (PCM) 52, an air conditioning control module (ACCM) 54, an Electronic Battery Control Module (EBCM) 56, a Steering Control Module (SCM) 58, a Brake System Control Module (BSCM) 60, and assorted other vehicle ECUs, such as a transmission control module (TCM), engine control module (ECM), Advanced Driver Assistance System (ADAS) module, Sensor System Interface Module (SSIM), etc.

With continuing reference to FIG. 1, telematics unit 14 is an onboard computing device that provides a mixture of services, both individually and through its communication with other networked devices. This telematics unit 14 may be generally composed of one or more processors 40, each of which may be embodied as a discrete microprocessor, an application specific integrated circuit (ASIC), or a dedicated control module. Vehicle 10 may offer centralized vehicle control via a central processing unit (CPU) 36 that is operatively coupled to a real-time clock (RTC) 42 and one or more electronic memory devices 38, each of which may take on the form of a CD-ROM, magnetic disk, IC device, a solid-state drive (SSD) memory, a hard-disk drive (HDD) memory, flash memory, semiconductor memory (e.g., various types of RAM or ROM), etc.

Long-range communication (LRC) capabilities with remote, off-board devices may be provided via one or more or all of a cellular chipset/component, a navigation and location chipset/component (e.g., global positioning system (GPS) transceiver), or a wireless modem, all of which are collectively represented at 44 in FIG. 1. Close-range wireless connectivity may be provided via a short-range communication (SRC) device 46 (e.g., a BLUETOOTH® unit or near field communications (NFC) transceiver), a dedicated short-range communications (DSRC) component 48, and/or a dual antenna 50. The communications devices described above may provision data exchanges as part of a periodic broadcast in a vehicle-to-vehicle (V2V) communication system or a vehicle-to-everything (V2X) communication system.

CPU 36 receives sensor data from one or more sensing devices that use, for example, photo detection, radar, laser, ultrasonic, optical, infrared, or other suitable technology, for executing a controller-automated (AV/ADAS) driving operation or a vehicle navigation service. In accord with the illustrated example, the automobile 10 may be equipped with one or more digital cameras 62, one or more range sensors 64, one or more vehicle speed sensors 66, one or more vehicle dynamics sensors 68, and any requisite filtering, classification, fusion, and analysis hardware and software for processing raw sensor data. The type, placement, number, and interoperability of the distributed array of in-vehicle sensors may be adapted, singly or collectively, to a given vehicle platform for achieving a desired level of automated vehicle operation.

To propel the motor vehicle 10, an electrified powertrain is operable to generate and deliver tractive torque to one or more of the vehicle's drive wheels 26. The powertrain is represented in FIG. 1 by an electric traction motor (M) 78 that is operatively connected to a rechargeable, chassis-mounted traction battery pack 70. The traction battery pack 70 is generally composed of one or more battery modules 72 each containing a cluster of battery cells 74, such as lithium-class or organosilicon-class cells of the pouch, prismatic, or cylindrical type. One or more electric machines, such as traction motor/generator (M) units 78, draw electrical power from and, optionally, deliver electrical power to the battery pack 70. A power inverter module (PIM) 80 electrically connects the battery pack 70 to the motor(s) 78 and modulates the transfer of electrical current therebetween. The battery pack 70 may include an integrated electronics package, such as a wireless-enabled cell monitoring unit (CMU) 76, that enables module management, cell sensing, and module communications functionality.

During operation of the motor vehicle 10 of FIG. 1, it may be desirable to harvest heat that is expelled from an HVAC system evaporator by effectively operating the evaporator as a condensing device to warm incoming ambient air and thereby improve cabin heating performance. Disclosed vehicle ATM systems may increase an air temperature of incoming ambient air using thermal energy recovered from low-pressure refrigerant before the refrigerant enters the HVAC system's cabin heating condenser. In addition to recovering refrigerant heat, disclosed vehicle ATM systems may increase refrigerant mass flow rate by opening additional flow paths on the low-pressure side with a concomitant increase in cabin heating capacity. Opening the evaporator flow path—traditionally closed for cabin heating mode—allows liquid refrigerant to flow through an expansion valve, which routes expanded, two-phase refrigerant through the evaporator.

Activation of the evaporator's expansion valve may be modulated in real-time to increase the two-phase refrigerant's temperature in order to ensure it is above the air temperature of ambient air flowing across the evaporator in the HVAC module. By ensuring that the refrigerant's temperature is higher than the ambient air's temperature, thermal energy is transferred from the two-phase refrigerant to the incoming air with a resultant increase to the air temperature before that air flows across the heating condenser and into the cabin. Doing so may increase the heating capacity of the cabin heating condenser and/or reduce the operational load on the heating condenser. The refrigerant exiting the evaporator may be either a two-phase or saturated/subcooled liquid, which would mix with cooled refrigerant exiting the chiller before being routed back to the high-pressure condenser branch of the circuit. After heating the cabin, the refrigerant flow path through the evaporator may be closed as the HVAC system transitions to a recirculation (recirc) mode.

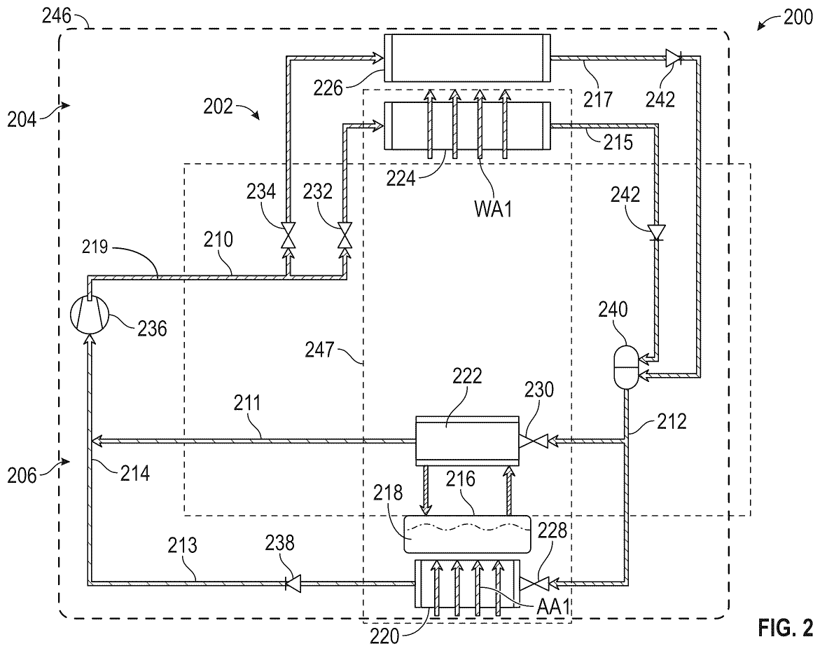

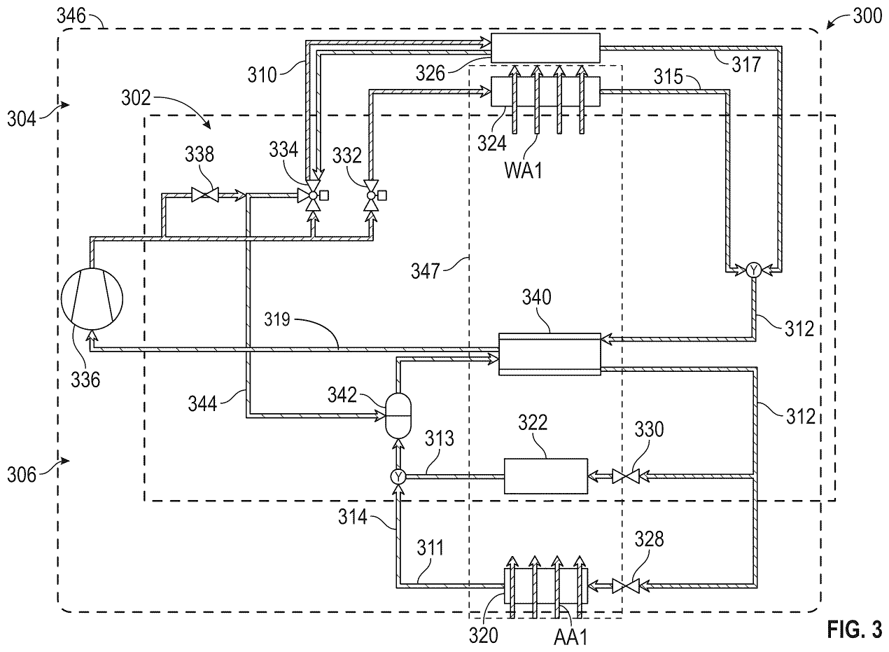

Motor vehicle 10 of FIG. 1 may be equipped with a controller-automated active thermal management system, such as RD-based vehicle ATM system 200 of FIG. 2 or ACC-based vehicle ATM system 300 of FIG. 3, for regulating cabin temperatures within a passenger cabin 11 of the vehicle body 12. For HEV and FEV applications, the vehicle ATM system 200, 300 may contain multiple fluidly discrete, independently operable thermal fluid loops that is each responsible for controlling a temperature level within a respective sub-system of the vehicle 10. These distinct thermal fluid loops may include a RESS (first) coolant loop for regulating the operating temperatures of select components within the vehicle's battery and high-voltage electrical system, a powertrain (second) coolant loop for regulating the operating temperatures of select components within the vehicle's powertrain system, and an HVAC (third) coolant loop for regulating the cabin temperature of the vehicle's passenger compartment 11. Examples of multiloop vehicle ATM systems may be found in commonly owned U.S. Pat. No. 11,541,719 B1, to Devin C. Richardson et al., and U.S. Pat. No. 11,072,259 B2, to Eugene V. Gonze, et al., both of which are incorporated herein by reference in their respective entireties and for all purposes. It is envisioned that disclosed techniques for recovering thermal energy from coolant fluids for optimized heating of vehicle compartments may be employed by other system architectures, including those with greater or fewer than three discrete thermal fluid loops.

With continued reference to FIGS. 2 and 3, the illustrated HVAC refrigerant loops of the vehicle RD-based and ACC-based ATM systems 200, 300 enable an occupant of the vehicle 10 to controllably increase and decrease a cabin temperature within the passenger compartment 11. Each refrigerant loop employs a string of interconnected refrigerant conduits, some of which are represented in FIGS. 2 and 3 by discharge line conduits 210 and 310, liquid line conduits 212 and 312, and suction line conduits 214 and 314, that collectively define a refrigerant coolant circuit 202 and 302. This coolant circuit 202, 302 fluidly connects a chiller fluid reservoir 216 with a chiller 222 and 322 in order to circulate thereto a coolant 218 (e.g., glycol and water) that is used to extract heat from a coolant fluid 219 and 319 (e.g., refrigerant) circulated through the circuit 202, 302. The coolant circuit may be bifurcated into a high-pressure (HP) circuit section 204 and 304, through which high-temperature and high-pressure refrigerant flows, and a low-pressure (LP) circuit section 206 and 306, through which low-temperature and low-pressure refrigerant flows. In both of the illustrated examples, the HP circuit section 204, 304 is thermally connected to the LP circuit section 206, 306, with the HP circuit section 204 of FIG. 2 fluidly connected in series with the LP circuit section 206 and the HP circuit section 304 of FIG. 3 fluidly connected in parallel with the LP circuit section 306.

On the low-pressure side of each refrigerant coolant circuit 202, 302, a heat-generating fluid evaporator 220 and 320 (e.g., orifice-tube or expansion-valve evaporator unit) may be fluidly coupled onto an evaporator (second) branch 213 and 311 of the LP circuit section 206, 306. The evaporator 220, 330 may be a heat exchange device that contains a series of serpentine coils that carries a flow of expanded and cooled refrigerant 219 and 319 or other similarly suitable coolant fluid. During a cabin cooling mode of operation, an HVAC blower/fan (not shown) may blow air over the cabin evaporator 220, 330; the evaporator coils extract thermal energy from the air, which is then transmitted into the passenger compartment 11 for controlled cabin cooling. The evaporator 220, 330 may be integrated with a dedicated flow-regulating (second) fluid valve 228 and 328 that is fluidly coupled to the LP section 206, 306 of the refrigerant coolant circuit 202, 302 upstream from a refrigerant inlet port of the evaporator 220, 320. In accord with the illustrated example, this fluid valve 228, 328 is a controller-activated electronic expansion valve (EXV1) that is interposed between the refrigerant inlet of the evaporator 220, 320 and a refrigerant outlet port of an HVAC cabin heating condenser (CHC) 224.

A fluid chiller 222 and 322 (e.g., liquid-cooler or air-cooled EV HVAC chiller unit) may be fluidly coupled onto a chiller (first) branch 211 and 313 of the LP circuit section 206, 306 in parallel fluid-flow communication with the evaporator branch 213, 311 and, thus, the evaporator 220, 320. Each chiller 222, 322 may be in the nature of a coolant-to-refrigerant heat sink that is equipped with an electronically controlled heat pump that selectively transfers heat out of the refrigerant 219, 319 flowing through the refrigerant coolant circuit 202. The chiller 222, 322 may be integrated with a dedicated flow-regulating (third) fluid valve 230 and 330 that is fluidly coupled to the LP section 206, 306 of the refrigerant coolant circuit 202, 302 upstream from the fluid chiller 222, 322 inlet port. In accord with the illustrated example, the chiller-integrated fluid valve 230, 330 is a controller-activated electronic expansion valve (EXV2) that is interposed between and selectively fluidly connects the CHC 224, 324 and the fluid chiller 222, 322.

On the high-pressure side of each circuit 202, 302, a refrigerant-heat extracting cabin condenser 224, 324 (e.g., air-cooled or liquid-cooled EV HVAC serpentine condenser unit) may be fluidly coupled onto an internal condenser (second) branch 215 and 315 of the HP circuit section 204, 304. Each CHC 224, 324 may be a heat exchange device equipped with condenser coils through which the refrigerant 219, 319 flows; these coils may be in direct fluid communication with cabin air inside the passenger compartment 11. An HVAC blower or fan (not shown) may blow air over the cabin condenser 224, 324 to thereby release thermal energy from the CHC 224, 324 into the passenger compartment. A dedicated flow-regulating (first) fluid valve 232 and 332 may be fluidly coupled to the HP section 204, 304 of the refrigerant coolant circuit 202, 302 upstream from a refrigerant inlet port of the CHC 224, 324. According to the examples of FIGS. 2 and 3, the CHC-side fluid valve 232, 332 is an electronic refrigerant flow-control valve (RFV1) that is interposed between and selectively fluidly connects the refrigerant inlet of the CHC 224, 324 and evaporator outlet ports of the evaporator 220, 320 and chiller 222, 322.

Also located on the high-pressure side of the refrigerant coolant circuit 202, 302 is a front-end “external” condenser 226 and 326 (e.g., fan-cooled AC condenser unit) that may be fluidly coupled onto an external condenser (first) branch circuit 217 and 317 of the HP circuit section 204, 304 in parallel fluid-flow communication with the internal condenser branch 215, 315 and, thus, the CHC 224, 324. External condenser (ECond) 226, 326 may be placed in direct contact with ambient air external to the vehicle 10; the vehicle ATM system 200, 300 may engage the external condenser 226, 326 to extract thermal energy from the refrigerant 219, 319 and expel the extracted energy to the atmosphere. When an occupant of the vehicle passenger compartment 11 selects a cabin cooling mode and sets an HVAC system temperature to a value below ambient temperature, the front-end condenser 226, 326 and cabin evaporator 220, 320 may be activated to cool refrigerant 219, 319 circulating through the refrigerant coolant circuit 202, 302. A dedicated flow-regulating (fifth) fluid valve 234 and 334 may be fluidly coupled to the HP section 204, 304 of the circuit 202, 302 upstream from a refrigerant inlet port of the external condenser 226, 326. Similar to the CHC-side fluid valve 232, 332, the ECond fluid valve 234, 334 may be an electronic refrigerant flow-control valve (RFV2) that is interposed between and selectively fluidly connects the refrigerant inlet of the condenser 226, 326 and evaporator outlet ports of the evaporator 220, 320 and chiller 222, 322.

Both the RD-based and ACC-based ATM systems 200, 300 of FIGS. 2 and 3 may fluidly couple a motor-driven fluid compressor 236 and 336 (e.g., air-conditioning electric compressor (ACEC) unit) to the refrigerant coolant circuit 202 and 302, fluidly interposed between the HP sections 204, 304 and the LP sections 206, 306. As the name implies, the compressor 236, 336 receives gaseous or multiphase refrigerant 219, 319 from the evaporator 220, 320 and chiller 222, 322 via the suction line 214, 314 and compresses the received refrigerant 219, 319 in order to increase the refrigerant's operating temperature and pressure. The now high-pressure, high-temperature refrigerant 219 leaves the compressor 236, 336 via the discharge line 210 and 310 and flows into the cabin heating condenser 224, 324 and/or external condenser 226, 326. For the RD-based system 200, a dedicated flow-regulating (fourth) fluid valve 238 may be fluidly coupled to the LP section 206 of the circuit 202 upstream from a refrigerant inlet port of the electric compressor 236. The ACEC-side fluid valve 238 may be a passive one-way check valve (CV) that selectively fluidly connects the evaporator 220 to the compressor 236 and prevents inadvertent backflow into the evaporator 220. In both HVAC system architectures, the CHC-side fluid valves 232, 332 and ECond fluid valves 234, 334 are respectively interposed between and selectively fluidly connect the CHC 224, 324 and Econd 226, 326 to the compressor 236, 336. An optional bypass valve 338 may be interposed between the electric compressor 336 and the RFV2 334.

RD-based vehicle ATM system 200 of FIG. 2 may employ a receiver dryer (RD) 240 (e.g., passive desiccant-bag or filter-pad HVAC RD unit) that is fluidly coupled to the liquid line 212 section of the refrigerant coolant circuit 202, interposed between the two condensers 224, 226 and both the evaporator 220 and chiller 222. Passive-type one-way check valves 242 may be fluidly interposed between the receiver dryer 240 and each of the condensers 224, 226. The receiver dryer 240 may contain a filter and a desiccant material to remove moisture, debris, and contaminants from the refrigerant 219. In addition to filtering and drying, the receiver dryer 240 may optionally act as a temporary storge container for condensed refrigerant 219.

In contrast to the ATM system 200 of FIG. 2, the ACC-based vehicle ATM system 300 of FIG. 3 may altogether omit an RD unit and instead incorporate an accumulator (ACC) 342 which may optionally be accompanied by an internal heat exchanger (IHX) 340. Acting as a thermodynamic bridge between otherwise fluidly segregated circuit segments, the IHX 340 is interposed between and thermally couples the HP section 304 and the LP section 306 of the coolant circuit 302. The IHX 340 may contain two internal fluid passageways that are physically isolated from each other: a first section of the IHX 340 defines a coolant passageway that carries high-pressure refrigerant 219 circulating through the HP circuit section 304; and a second section of the IHX 340 defines a refrigerant passageway that carries low-pressure refrigerant 219 circulating through the HP circuit section 306. Other than an optional bypass line 344 fluidly connecting the ECond 326 to the ACC 342, there may be no other direct fluid connection between the HP and LP sections 304, 306 of the coolant circuit 302. The accumulator 342 is fluidly coupled to the suction line conduits 314 in the LP circuit section 306, interposed between the IHX 340 and both the evaporator 320 and chiller 322. Accumulator 342 of FIG. 3 may selectively store therein a portion of the refrigerant 219 exiting the evaporator 320, chiller 322, or external condenser 326 in order to reduce a refrigerant pressure within the LP section 306 of the coolant circuit 302.

To help optimize cabin heating performance, the vehicle ATM systems 200, 300 recover refrigerant heat from the evaporator branch of the refrigerant coolant circuits 202, 302 to warm incoming air as it is fed into the cabin heating condenser 224, 324. By way of non-limiting example, select HVAC hardware components of each ATM system 200, 300 may be packaged inside a protective HVAC module housing 246 and 346 (note: chiller typically not packaged inside HVAC module). An air passage 247 and 347, which may be in the nature of an ambient air-intake vent and internal air ductwork of the module housing 246, 346, fluidly connects the LP-side evaporator 220, 320 with the HP-side CHC 224, 324. This air passage 247, 347 receives ambient air AA1, e.g., drawn in by an intake blower or fan (not shown) from outside the motor vehicle 10, and passes the ambient air AA1 across the cabin evaporator 220, 320. Refrigerant heat expelled from the evaporator 220, 320 convectively heats the incoming ambient air AA1; the air passage 247, 347 transmits this warmed ambient air WA1 into the cabin condenser 224, 324 to thereby heat the vehicle's passenger cabin 11.

Operation of the vehicle ATM systems 200, 300 may be governed by a resident or remote system controller, such as vehicle CPU 36 and/or ACCM 54 of FIG. 1, to provision cabin heating and cabin cooling operating modes. Upon receipt of a request to heat the passenger cabin 11, e.g., from a vehicle occupant using telematics user input controls 32 of FIG. 1, the ACCM 54 may concurrently open both the EXV1 228, 328 and RFV1 232, 332 fluid valves to thereby transmit refrigerant 219 through the RFV1 fluid valve 232, 332, the CHC 224, 324, the EXV1 fluid valve 228, 328, and the evaporator 220, 320. Refrigerant heat recovery is enabled by running the evaporator 220, 320 as a condenser with the refrigerant temperature maintained at a value higher than an air temperature of the ambient air AA1 through selective modulation of the pressure and temperature drop imparted by the thermostatic EXV1 228, 328. During heating of the vehicle passenger cabin 11, the ACCM 54 may also open the EXV2 fluid valve 230, 330 concurrent with the opening of the EXV1 228, 328 and RFV1 232, 332 fluid valves such that refrigerant 219 is also transmitted through the cabin chiller 222, 322, e.g., with a concomitant increase in refrigerant mass flow. The ACCM 54 may also close the RFV2 fluid valve 234, 334 contemporaneous with the opening of the EXV1 228, 328, EXV2 230, 330 and RFV1 232, 332 fluid valves to prevent refrigerant 219 from passing through the external condenser 226, 326 during cabin heating.

Aspects of the present disclosure have been described in detail with reference to the illustrated embodiments; those skilled in the art will recognize, however, that many modifications may be made thereto without departing from the scope of the present disclosure. The present disclosure is not limited to the precise construction and compositions disclosed herein; any and all modifications, changes, and variations apparent from the foregoing descriptions are within the scope of the disclosure as defined by the appended claims. Moreover, the present concepts expressly include any and all combinations and subcombinations of the preceding elements and features.

What is claimed:

1. A thermal management system for a motor vehicle, the motor vehicle having a vehicle body with a vehicle passenger cabin, the thermal management system comprising:
a coolant reservoir configured to attach to the vehicle body and stow coolant fluid;
a coolant circuit fluidly coupled to the coolant reservoir and configured to attach to the vehicle body and circulate the coolant fluid, the coolant circuit having a high-pressure (HP) circuit section and a low-pressure (LP) circuit section;
a cabin heating condenser (CHC) fluidly coupled to the HP circuit section;
an evaporator fluidly coupled to the LP circuit section; and
an air passage fluidly connected to the evaporator and the CHC, the air passage configured to receive ambient air from outside the motor vehicle, pass the ambient across the evaporator to thereby generate warmed ambient air, and transmit the warmed ambient air into the CHC to thereby heat the vehicle passenger cabin.

2. The thermal management system of claim 1, further comprising:
a first fluid valve fluidly coupled to the HP circuit section upstream from the CHC and selectively fluidly connecting the evaporator to the CHC;
a second fluid valve fluidly coupled to the LP circuit section upstream from the evaporator and selectively fluidly connecting the CHC to the evaporator; and
a system controller programmed to concurrently open both the first and second fluid valves to thereby pass the coolant fluid through the first fluid valve, the CHC, the second fluid valve, and the evaporator during the heating of the vehicle passenger cabin.

3. The thermal management system of claim 2, wherein the first fluid valve is an electronic refrigerant flow valve (RFV) interposed between an evaporator outlet of the evaporator and a CHC inlet of the CHC, and the second fluid valve is an electronic expansion valve (EXV) interposed between an evaporator inlet of the evaporator and a CHC outlet of the CHC.

4. The thermal management system of claim 2, further comprising a fluid chiller fluidly coupled to a first LP branch circuit of the LP circuit section and configured to extract thermal energy from the coolant fluid, wherein the evaporator is fluidly coupled to a second LP branch circuit fluidly connected in parallel to the first LP branch circuit.

5. The thermal management system of claim 4, further comprising:
a third fluid valve fluidly coupled to the LP circuit section upstream from the fluid chiller and selectively fluidly connecting the CHC to the fluid chiller,
wherein the system controller is further programmed to concurrently open the third fluid valve with the first and second fluid valves such that the coolant fluid passes through the first fluid valve, the CHC, the second and third fluid valves, and the evaporator and the fluid chiller during the heating of the vehicle passenger cabin.

6. The thermal management system of claim 2, further comprising an electric compressor fluidly coupled to the coolant circuit interposed between the evaporator and the CHC, the electric compressor configured to increase a temperature and a pressure of the coolant fluid.

7. The thermal management system of claim 6, further comprising:
a fourth fluid valve fluidly coupled to the LP circuit section upstream from the electric compressor and selectively fluidly connecting the evaporator to the electric compressor,
wherein the first fluid valve is fluidly interposed between and selectively fluidly connects the electric compressor to the CHC.

8. The thermal management system of claim 2, further comprising an external condenser fluidly coupled to a first HP branch circuit of the HP circuit section and configured to expel thermal energy from the coolant fluid into the ambient air outside the motor vehicle, wherein the CHC is fluidly coupled to a second HP branch circuit parallel to the first HP branch circuit.

9. The thermal management system of claim 8, further comprising:
a fifth fluid valve fluidly coupled to the HP circuit section upstream from the external condenser and selectively fluidly connecting the external condenser to the evaporator,
wherein the system controller is further programmed to close the fifth fluid valve concurrent with the opening of the first and second fluid valves such that the coolant fluid does not pass through the external condenser during the heating of the vehicle passenger cabin.

10. The thermal management system of claim 2, further comprising a receiver dryer fluidly coupled to the coolant circuit interposed between the evaporator and the CHC, the receiver dryer configured to remove moisture from the coolant fluid.

11. The thermal management system of claim 10, further comprising:
a sixth fluid valve interposed between and selectively fluidly connecting the CHC to the receiver dryer,
wherein the second fluid valve is fluidly interposed between and selectively fluidly connects the receiver dryer to the evaporator.

12. The thermal management system of claim 1, further comprising an internal heat exchanger (IHX) interposed between and thermally coupling the LP circuit section and the HP circuit section of the coolant circuit.

13. The thermal management system of claim 12, further comprising an accumulator fluidly coupled to the LP circuit section interposed between the evaporator and the IHX, the accumulator configured to selectively store therein a portion of the coolant fluid and thereby reduce a fluid pressure in the LP circuit section of the coolant circuit.

14. A motor vehicle comprising:
a vehicle body with a passenger cabin;
a plurality of road wheels attached to the vehicle body;
a prime mover attached to the vehicle body and operable to drive one or more of the road wheels to thereby propel the motor vehicle; and
an active thermal management (ATM) system attached to the vehicle body and operable to regulate a cabin temperature of the passenger cabin, the ATM system including:
a coolant reservoir configured to stow coolant fluid;
a coolant circuit fluidly coupled to the coolant reservoir and configured to circulate the coolant fluid to cool and heat the passenger cabin, the coolant circuit having a high-pressure (HP) circuit section and a low-pressure (LP) circuit section;
a cabin heating condenser (CHC) fluidly coupled to the HP circuit section;
an evaporator fluidly coupled to the LP circuit section;
a module housing with an air passage fluidly connecting the evaporator and the CHC, the air passage configured to receive ambient air from outside the motor vehicle, pass the ambient across the evaporator to generate warmed ambient air, and transmit the warmed ambient air into the CHC to thereby heat the passenger cabin;
a first fluid valve fluidly coupled to the HP circuit section upstream from the CHC and selectively fluidly connecting the evaporator to the CHC;
a second fluid valve fluidly coupled to the LP circuit section upstream from the evaporator and selectively fluidly connecting the CHC to the evaporator; and
a system controller programmed to concurrently open both the first and second fluid valves to pass the coolant fluid through the first fluid valve, the CHC, the second fluid valve, and the evaporator to heat the vehicle passenger cabin.

15. A method of assembling a thermal management system for a motor vehicle, the motor vehicle having a vehicle body with a vehicle passenger cabin, the method comprising:
attaching a coolant reservoir to the vehicle body, the coolant reservoir being configured to stow coolant fluid;
attaching a coolant circuit to the vehicle body, the coolant circuit having a high-pressure (HP) circuit section and a low-pressure (LP) circuit section;
fluidly coupling the coolant circuit to the coolant reservoir, the coolant circuit being configured to circulate the coolant fluid;
fluidly coupling a cabin heating condenser (CHC) to the HP circuit section;
fluidly coupling an evaporator to the LP circuit section; and
fluidly connecting an air passage to the evaporator and the CHC, the air passage being configured to receive ambient air from outside the motor vehicle, pass the ambient across the evaporator to thereby generate warmed ambient air, and transmit the warmed ambient air into the CHC to thereby heat the vehicle passenger cabin.

16. The method of claim 15, further comprising:
fluidly coupling a first fluid valve to the HP circuit section upstream from the CHC, the first fluid valve being configured to selectively fluidly connect the evaporator to the CHC;
fluidly coupling a second fluid valve to the LP circuit section upstream from the evaporator, the second fluid valve being configured to selectively fluidly connect the CHC to the evaporator; and
commanding, via a system controller responsive to receipt of a request to heat the vehicle passenger cabin, the first and second fluid valves to open and thereby pass the coolant fluid through the first fluid valve, the CHC, the second fluid valve, and the evaporator.

17. The method of claim 16, further comprising fluidly coupling a fluid chiller to a first LP branch circuit of the LP circuit section, the fluid chiller configured to extract thermal energy from the coolant fluid, wherein the evaporator is fluidly coupled to a second LP branch circuit fluidly connected in parallel to the first LP branch circuit.

18. The method of claim 17, further comprising:
fluidly coupling a third fluid valve to the LP circuit section upstream from the fluid chiller, the third fluid valve being configured to selectively fluidly connect the CHC to the fluid chiller; and
commanding, via the system controller responsive to receipt of the request to heat the vehicle passenger cabin, the third fluid valve to open with the first and second fluid valves such that the coolant fluid passes through the first fluid valve, the CHC, the second and third fluid valves, and the evaporator and the fluid chiller.

19. The method of claim 18, further comprising fluidly coupling an electric compressor to the coolant circuit interposed between the evaporator and the CHC, the electric compressor being configured to increase a temperature and a pressure of the coolant fluid.

20. The method of claim 19, further comprising fluidly coupling an external condenser to a first HP branch circuit of the HP circuit section, the external condenser being configured to expel thermal energy from the coolant fluid into the ambient air outside the motor vehicle, wherein the CHC is fluidly coupled to a second HP branch circuit fluidly connected in parallel to the first HP branch circuit.
